(19) United States
(12) Patent Application Publication
(10) Pub. No.: US 2004/0056832 A1
(43) Pub. Date: Mar. 25, 2004

(54) Driving circuit and voltage generating circuit and display using the same

(75) Inventor: Katsumi Abe, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/664,969

(22) Filed: Sep. 22, 2003

(30) Foreign Application Priority Data
Sep. 25, 2002 (JP) 278274/2002

(51) Int. Cl. G09G 3/36

(52) U.S. Cl. 345/90

(57) ABSTRACT

A drive circuit with a first voltage supply, and a second voltage supply that provides a voltage that is lower than the first voltage supply. The drive circuit also has a first transistor with either a drain or a source terminal connected to the first voltage supply, and a second transistor with either a drain or source terminal connected to the second voltage supply. A signal line is connected to each gate terminal of the first and second transistors, and at least one capacitance load is connected to respective terminals of the first and the second transistors that are not connected to the first and second voltage supplies. The signal line conveys signals having a high level that is substantially the same or higher than the voltage of the first voltage supply and a low level that is substantially the same or lower than the voltage of the second voltage supply.

### BACKGROUND OF THE INVENTION

1. Field of the Invention

The present invention relates to a drive circuit and a voltage generating circuit and a display unit, and more particularly, to circuits and an arrangement thereof in integrating the load drive circuit and the voltage generating circuit on the same substrate as that of the display unit.

2. Description of the Related Art

A liquid crystal display is used in various fields for its advantages such as light weight, thin cross-section and low power consumption compared to a CRT (Cathode Ray Tube).

An active matrix liquid crystal display, as shown in FIG. 1, has a liquid crystal display portion 11 in which pixels having amorphous silicon (a-Si) thin-film transistors (TFT) as switching elements are arranged in a matrix on a glass substrate.

This liquid crystal display is externally equipped with data driver ICs (integrated circuits) 21-1 to 21-5 for driving data lines, gate driver ICs 31-1 to 31-8 for controlling switching of pixels of each line, a common drive circuit IC 40 for driving a common electrode opposed to a picture electrode by sandwiching a liquid crystal layer, and a power circuit IC 50 for providing a voltage to the data driver circuits and to the gate driver circuits.

If the voltage applied to the liquid crystal layer is constantly, DC components are applied to the liquid crystal portion 11 for a long time, which causes problems such as degradation of liquid crystal characteristics. Japanese published application 11-194320A and Japanese published application 11-194316A disclose a frame inversion drive for inverting a polarity of the voltage applied to the liquid crystal portion 11 for each frame or a line inversion drive for inverting the polarity of the voltage applied to the liquid crystal portion 11 for each line to avoid the above-disclosed problem.

Furthermore, “Low Temperature Poly-Si TFT-LCD with Integrated Analog Circuit” (T. Nakamura, et al., Asia Display/IDW' 01 Proceedings, Oct. 16, 2001, pp. 1603-1606m, and “A 5-in, SVGA TFT-LCD with Integrated Multiple DAC Using Low-Temperature poly-Si TFTs” (Y. Mikami, et al., Asia Display/IDW' 01 Proceedings, Oct. 16, 2001, pp. 1607-1610) disclose a glass substrate integrated on not only pixel switching elements but also various circuits by a polysilicon (p-Si) TFT technology having higher current capability than a-Si TFT.

In a liquid crystal display used for a cell-phone unit having a load of several picofarads, a data driver circuit 22 and gate drivers 32-1 and 32-2 are mounted on the same substrate 10 as that of the pixels in the liquid crystal display shown in FIG. 2. Thus, it is possible to reduce the number of parts and connections required for the liquid crystal display so as to reduce the costs and provide high reliability.

The common drive circuit IC 40 for performing the line inversion drive drives the common electrode at an H level (VCOMH) and an L level (VCOML) in each horizontal period. In this case, to simultaneously drive the common electrodes of all the pixels in the liquid crystal display, the common drive circuit IC 40 needs to drive a large load of several nanofarads or more at a high speed.

For that reason, a bipolar transistor with high current capability or a single-crystal Si MOSFET (Metal-Oxide-Semiconductor Field-Effect Transistor) with a large gate width have conventionally been used in an output stage of the common drive circuit IC 40.

If the common drive circuit IC 40 as described above could be configured using a p-Si TFT and mounted on the same substrate 10 as that of the pixels in the liquid crystal display, it would be provide the same advantages to reduce the costs and provide high reliability as in the case of mounting the data drivers and gate drivers.

However, to mount the common drive circuit IC 40, a TFT having a gate width of 10 mm or so is necessary in the output stage of the common drive circuit IC 40 because the current capability of the p-Si TFT is on the order of one-tenth of the Si MOSFET.

Furthermore, it is also necessary to consider influence of wiring resistance on driving speed. Therefore, to mount the common drive circuit IC 40 on the same substrate 10 as that of the pixels in the liquid crystal display, a large area for placing the common drive circuit IC 40 must be saved in a non-display portion, thereby making it difficult to make the frame narrower.

Although a symmetric frame design is required for the entire liquid crystal display including the drive circuit, it is not easy to make the frame symmetric in arranging the common drive circuit IC 40.

In the conventional liquid crystal display, as described above, there is a problem that the common drive circuit using the TFT requires larger area because the TFT has lower current capability than the bipolar transistor and single-crystal Si MOSFET.

In addition, in the conventional liquid crystal display, there is another problem that the common drive circuit has large circuit area and is easily influenced by wiring resistance, and requires a wide and asymmetric frame in order to place the common drive circuit using the TFT on the same substrate as that of the pixels in the liquid crystal display.

### SUMMARY OF THE INVENTION

An aspect of the present invention is to provide a drive circuit and a voltage generating circuit and a display unit that solves the above problems.

According to a first aspect of the present invention, a drive circuit comprises a first voltage supply, a second voltage supply for providing a voltage that is lower than a voltage of the first voltage supply, at least one first transistor including either a drain or a source terminal connected to the first voltage supply, at least one second transistor including either a drain or source terminal connected to the second voltage supply, at least one signal line connected to each gate terminal of the first and second transistor, and at least one capacitance load connected to respective terminals of the first and the second transistors not connected to the first and second voltage supplies, wherein the signal line conveys signals having a high level that is substantially the same or higher than the voltage of the first voltage supply and having a low level that is substantially the same or lower than the voltage of the second voltage supply.

Thus, according to a first aspect of the present invention, it is possible to reduce the ON resistance of the drive circuit and shorten the gate length of the transistors. Therefore, it is possible to make the circuit area small.

According to a second aspect of the present invention, a voltage generating circuit for generating a providing voltage to a drive circuit comprises a first and a second variable resistances for adjusting the providing voltage, a first operational amplifier outputting a high level of the providing voltage, and a non-inversion input thereof connected to a variable portion of the second variable resistance, a second operational amplifier outputting a low level of the providing voltage, and a non-inversion input thereof connected to a variable portion of the second variable resistance, a first resistance connecting a variable portion of the first variable resistances to an inversion input of the first operational amplifier, a second resistance wherein one terminal of the second resistance connected to the inversion input of the first operational amplifier, and the other terminal of the second resistance connected to output of the first operational amplifier, a third resistance connecting a constant voltage supply to an inversion input of the second operational amplifier, a fourth resistance wherein one terminal of the fourth resistance connects to a inversion input of the second operational amplifier, and the other terminal of the fourth resistance connects to an output of the second operational amplifier, wherein total resistance of the first variable resistance is a resistance value of one third or less of at least one of the total resistance of the second variable resistance and resistance of the first operational amplifier, the second operational amplifier, the first resistance, the second resistance, the third resistance, and the fourth resistance, and wherein the first and second variable resistances adjust a low level of the providing voltage and a voltage difference between a high level and the low level of the providing voltage.

Thus, according to the second aspect of the present invention, adjustment of the voltage level of the drive circuit can be adjusted easily.

According to a third aspect of the present invention, a display comprising a substrate, a display portion integrated on the substrate, a gate driver circuit for controlling switching of pixels of each line in a display portion, a drive circuit for a display portion for simultaneously driving capacitance loads in the display portion, wherein the drive circuit are disposed on a position opposite to the gate driver circuit and the display portion therebetween.

Thus, according to the third aspect of the present invention, it is possible to make the symmetric frame and narrower frame without lowering the drive capability of the drive circuit.

### BRIEF DESCRIPTION OF THE DRAWINGS

FIG. 1 is a diagram showing the example of a configuration of the conventional liquid crystal display.

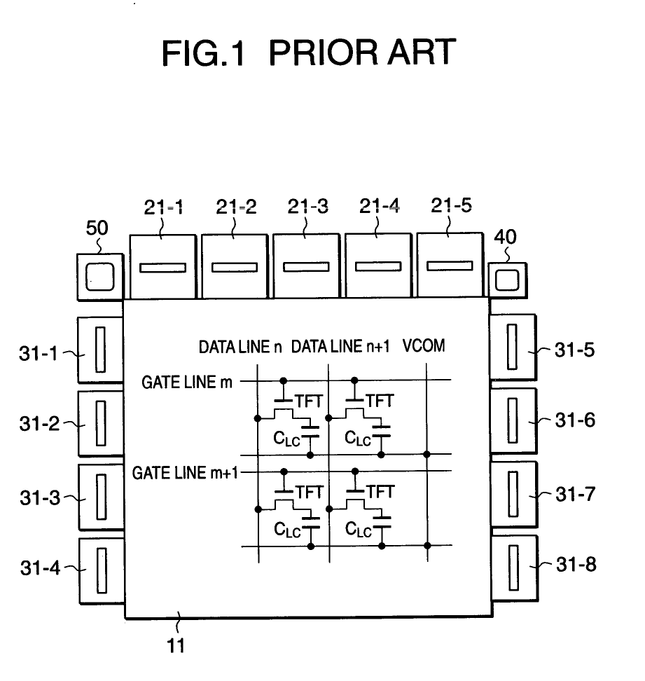

FIG. 2 is a diagram showing the configuration example of the conventional liquid crystal display.

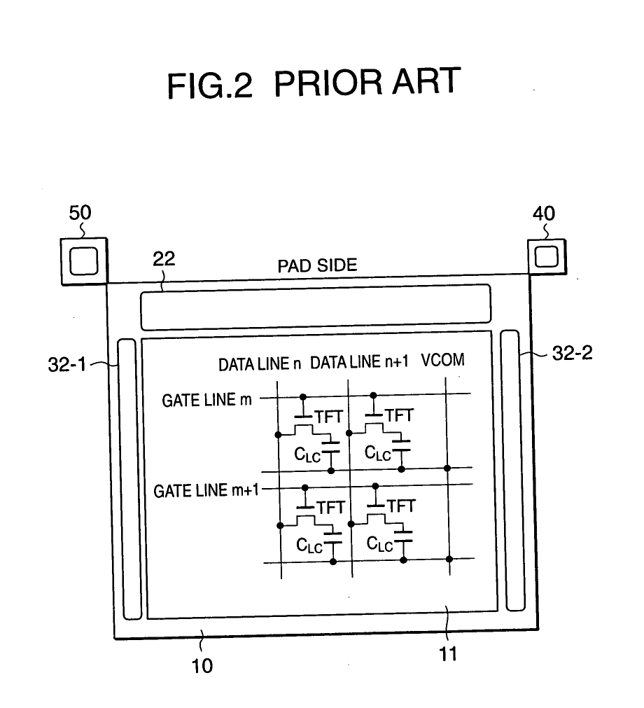

FIG. 3 is a diagram showing a configuration of a liquid crystal display substrate according to a first embodiment of the present invention.

FIG. 4 is a diagram showing a first configuration example of a common drive circuit in FIG. 3.

FIG. 5 is a timing chart showing operation of the common drive circuit in FIG. 4.

FIG. 6 is a diagram showing a second configuration example of the common drive circuit in FIG. 3.

FIG. 7 is a diagram showing a third configuration example of the common drive circuit in FIG. 3.

FIG. 8 is a diagram showing the configuration of the liquid crystal display substrate according to a second embodiment of the present invention.

FIG. 9 is a diagram showing the configuration of a common voltage generating circuit in FIG. 8.

FIG. 10 is a diagram showing an example of combining the common voltage generating circuit in FIG. 9 with the common drive circuit in FIG. 6.

### DETAILED DESCRIPTION OF THE INVENTION

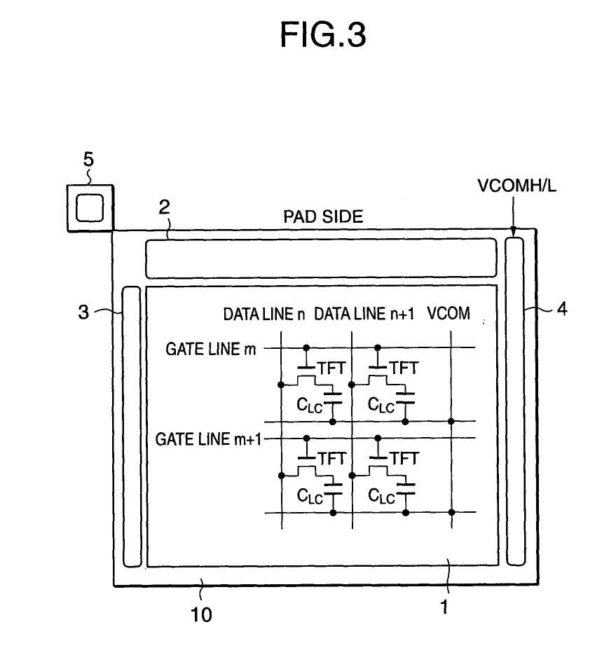

FIG. 3 is a diagram showing a configuration of a liquid crystal display substrate according to a first embodiment of the present invention. In FIG. 3, a liquid crystal display substrate 10 mounts a liquid crystal display portion 1 having pixels disposed in a matrix, a data driver circuit 2 for driving a data line of the liquid crystal display portion 1, a gate driver circuit 3 for controlling switching of the pixels of each line of the liquid crystal display portion 1, and a common drive circuit 4 for simultaneously driving common electrodes of all the pixels of the liquid crystal display. The common drive circuit is mounted on the position opposed to a picture electrode of the liquid crystal display portion 1 by sandwiching a liquid crystal layer. In addition, a power circuit IC 5 for supplying a voltage to the driver circuit and the drive circuit are on the outside of the liquid crystal display substrate.

The liquid crystal display substrate 10 has the data driver circuit 2 and gate driver circuit 3 for driving the liquid crystal display integrated thereon together with the common drive circuit 4, where common voltages VCOMH and VCOML are applied from the outside through a pad.

The gate driver circuit 3 is disposed on to be along one side of the four sides of the substrate. The common drive circuit 4 is disposed on the opposite side from where the gate driver circuit 3 is disposed and as close to the pad as possible while having almost the same width as the area of the gate driver circuit 3. Moreover, the pad close to the common drive circuit 4 is used as the pad for applying the common voltages VCOMH and VCOML.

According to this embodiment, the gate driver is disposed on the same substrate as the liquid crystal display, the common drive circuit is disposed at the opposite side to the side at which the gate driver is disposed. Thereby it is possible to make the frame of the liquid crystal display symmetric with a width nearly equal to that of the gate driver. Furthermore, the common drive circuit is disposed close to the pad in the case where the common voltages VCOMH and VCOML are supplied from an input pad of the liquid crystal display, and the common drive circuit is disposed close to the common voltage generating circuit in the case where the common voltage generating circuit is disposed on the same substrate. Therefore, it is possible to prevent a wiring load and to shorten the driving time of the common electrode by the common drive circuit.

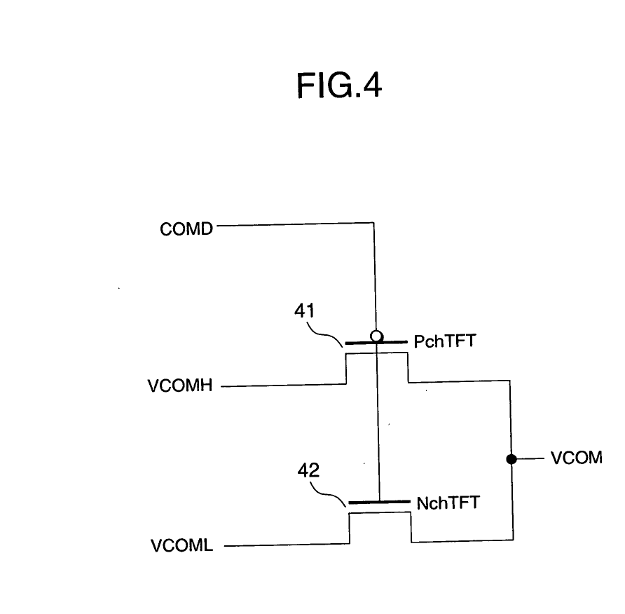

FIG. 4 is a diagram showing a first configuration example of the common drive circuit 4 in FIG. 3. As shown in FIG. 4, the common drive circuit 4 is comprised of two common level power lines (VCOMH and VCOML), the common electrode in the liquid crystal display, a common inversion'timing signal line COMD, a PchTFT (TFT: Thin Film Transistor) 41 and an NchTFT 42.

One terminal of a drain and a source of the PchTFT 41 is connected to an H-level common voltage VCOMH power line and the other terminal is connected to the common electrode. One terminal of the drain and source of the NchTFT 42 is connected to an L-level common voltage VCOML power line and the other terminal is connected to the common electrode.

The gates of the PchTFT 41 and NchTFT 42 are connected to the common inversion timing signal line COMD so as to make the H level of the COMD higher than the VCOMH and the L level of the COMD lower than the VCOML.

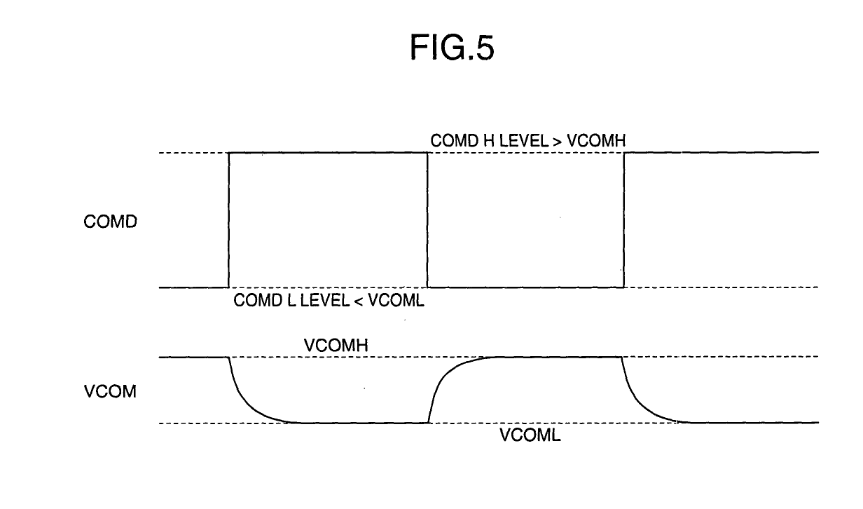

FIG. 5 is a timing chart showing operation of the common drive circuit 4 in FIG. 4.

According to this embodiment, a voltage difference between the gate and source of the PchTFT 41 and NchTFT 42 is larger compared to the voltages VCOMH and VCOML so that ON resistances of the PchTFT 41 and NchTFT 42 can be lowered.

Since only the voltages VCOMH and VCOML are carried between the drain and source of the PchTFT 41 and NchTFT 42, the gate length of the PchTFT 41 and NchTFT 42 can be shortened according to two common level amplitudes.

According to this embodiment, the common drive circuit 4 can make the gate width of the PchTFT 41 and NchTFT 42 smaller, thereby making the circuit area smaller.

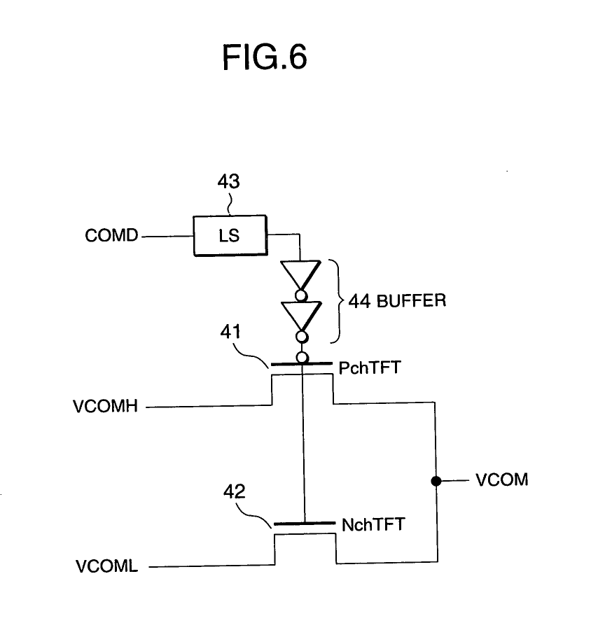

FIG. 6 is a diagram showing a second configuration example of the common drive circuit 4 in FIG. 3. As shown in FIG. 6, the common drive circuit 4 is different from the first configuration example of the common drive circuit 4 shown in FIG. 4 in having a common inversion timing signal buffer 44.

An input signal of common inversion timing may have drive capability of a substantially normal input signal. It can make the input signal of common inversion timing low-voltage-level by further providing a level shift (LS) 43 between the common inversion timing signal buffer 44 and a common inversion timing signal line COMD.

Furthermore, according to this embodiment, a common inversion signal applied to the gates of the PchTFT 41 and NchTFT 42 can use power of the gate driver circuit 3 used for the liquid crystal display. Accordingly, there is an advantage that it is no longer necessary to newly prepare a voltage level for the common drive circuit.

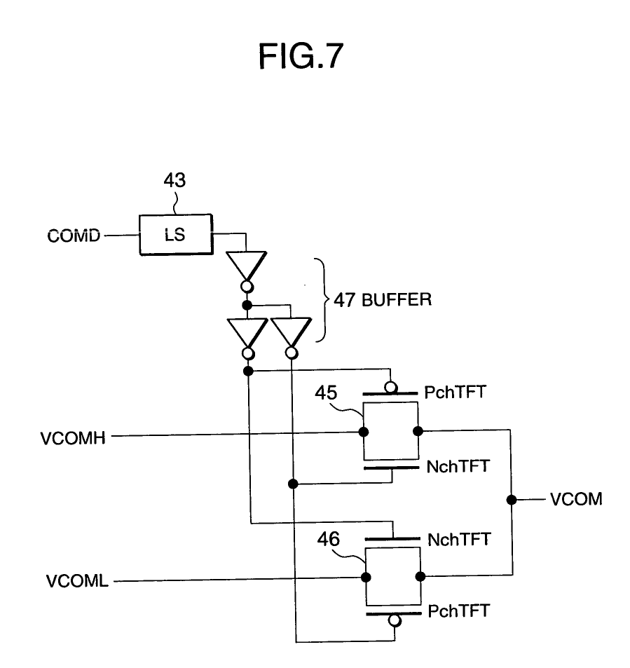

FIG. 7 is a diagram showing a third configuration example of the common drive circuit 4 in FIG. 3. In FIG. 7, instead of the PchTFT 41 and NchTFT 42, the common drive circuit 4 uses switches 45 and 46 of a CMOS (Complementary Metal Oxide Semiconductor) structure for combining the PchTFT and NchTFT as one switch and has the common inversion timing signal buffer 47.

In this case, the switches 45 and 46 are timing-controlled by the common inversion timing signal and inversion signal thereof, and so either the common inversion timing signal and inversion signal thereof are inputted from the outside or the inversion signal of the common inversion timing signal is generated from the common inversion timing signal through an inverter.

According to this embodiment, it is possible to make the circuit area small and make the frame narrower by adopting each of the examples as the common drive circuit 4. This embodiment is also applicable to the case where the data driver circuit 2 is not integrated on the liquid crystal display substrate 10 and the case where the other circuits are integrated thereon.

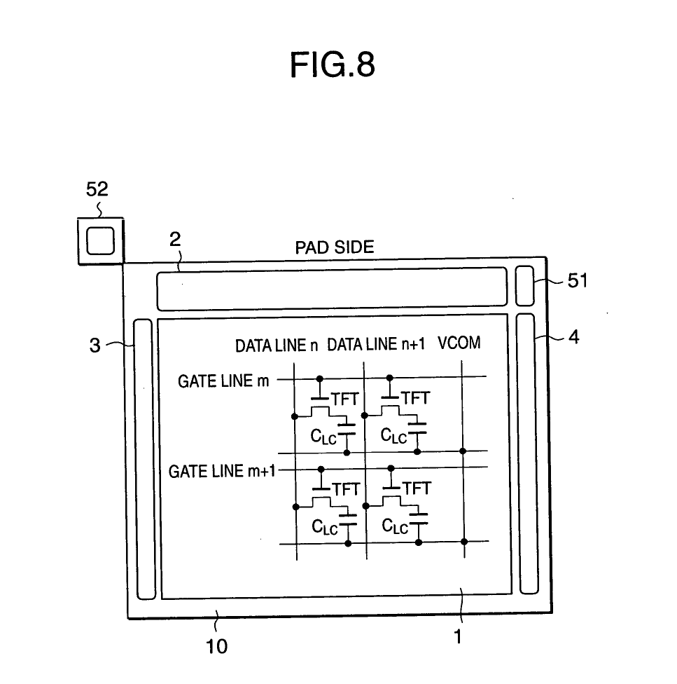

FIG. 8 is a diagram showing the configuration of the liquid crystal display substrate according to a second embodiment of the present invention. In FIG. 8, the liquid crystal display substrate 10 mounts the display portion 1, data driver circuit 2, gate driver circuit 3, common drive circuit 4 and a common voltage generating circuit 51. A power circuit IC 52 for supplying the voltage to the driver circuit and drive circuit is provided on the outside of the substrate.

The data driver circuit 2 and the gate driver circuit 3 are integrated with the common drive circuit 4 and common voltage generating circuit 51 on the substrate, and common voltages VCOMH and VCOML are applied from the outside through a pad.

The gate driver circuit 3 is disposed on to be along one side of four sides of the liquid crystal display. The common voltage generating circuit 51 is disposed adjacent to the pad on the opposite side to where the gate driver circuit 3. The pad closed to the common voltage generating circuit 51 is used as the pad to which the power, voltage, external resistance and external capacity used by the common drive circuit 4 are connected.

The common drive circuit 4 is disposed to be adjacent to the opposite side to where the gate driver circuit 3 is disposed while having almost the same width as the area of the gate driver circuit 3 and being adjacent to the common voltage generating circuit 51.

According to this embodiment, it is possible to make the frame symmetric as the entire liquid crystal display including the gate driver circuit 3, common voltage generating circuit 51 and common drive circuit 4. In addition, by placing the common voltage generating circuit 51 close to the pad and placing the common drive circuit 4 close to the common voltage generating circuit 51, it is possible to reduce the influence of wiring resistance and to prevent delay in driving the common electrode by the common drive circuit 4.

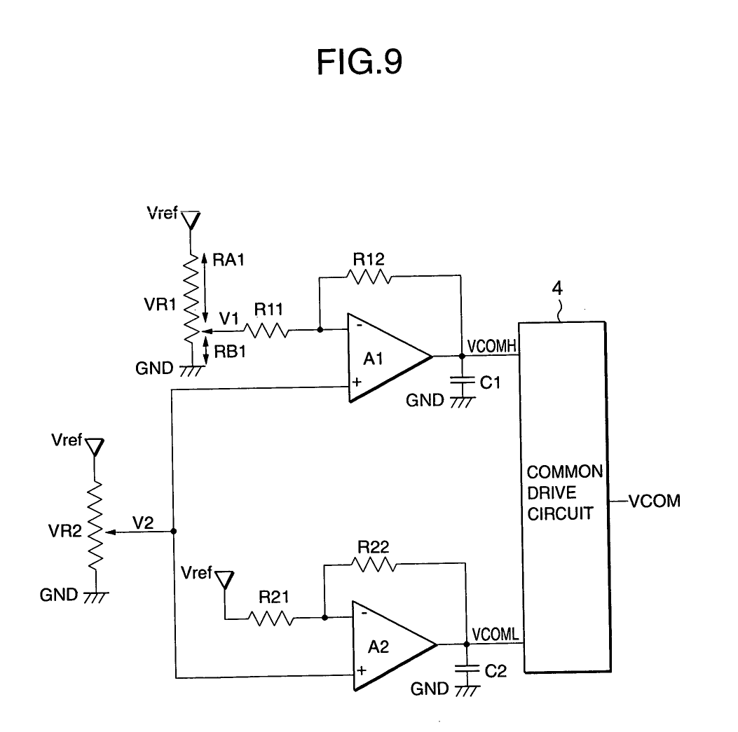

FIG. 9 is a diagram showing the configuration of the common voltage generating circuit 51 in FIG. 8. FIG. 9 shows the common drive circuit 4 and common voltage generating circuit 51. Each of the above configuration examples is adaptable as the configuration of the common drive circuit 4.

In an illustrative embodiment of the present invention, the common voltage generating circuit 51 is the circuit for generating the common voltages (VCOMH and VCOML). The common voltage generating circuit 51 is comprised of a variable resistance (VR1) for adjusting the voltage difference between the common voltages VCOMH and VCOML, the variable resistance (VR2) for adjusting the level of the VCOML, the four resistances (R11, R12, R21 and R22), the two operational amplifiers (A1 and A2) and two capacitances (C1 and C2), and has adequate constant voltage (Vref) inputted thereto. Furthermore, a total resistance value of the variable resistance VR1 is one third or less of the resistance R11. Capacity values of the two capacitances C1 and C2 are at least 100 times larger than a total of common electrode capacity values of the liquid crystal display. These capacity values are sufficiently large, therefore there is almost no influence of a voltage drop.

An inversion input terminal of an operational amplifier A1 has the resistances R11 and R12 connected in parallel thereto. The other terminal of the resistance R11 is connected to the variable portion of the variable resistance VR1 and the other terminal of the resistance R12 is connected to the output of the operational amplifier A1, respectively. A non-inversion input terminal of the operational amplifier A1 is connected to the variable portion of the variable resistance VR2. The capacitance C1 is connected to the output of the operational amplifier A1. This output outputs the common voltage VCOMH.

The inversion input terminal of an operational amplifier A2 has the resistances R21 and R22 connected in parallel thereto. The other terminal of the resistance R21 is connected to the constant voltage Vref and the other terminal of the resistance R22 is connected to the output of the operational amplifier A2, respectively. The non-inversion input terminal of the operational amplifier A2 is connected to the variable portion of the variable resistance VR2. The capacitance C2 is connected to the output of the operational amplifier A2. This output outputs the common voltage VCOML. Both terminals of the variable resistances VR1 and VR2 are connected to the constant voltages Vref and GND.

If the resistance from the variable portion of the variable resistance VR1 to the constant voltage Vref is RA1, the resistance from the variable portion to the GND is RB1, and the voltage of the variable portion of the variable resistance VR2 is V2, the voltage V1 of the variable portion of the variable resistance VR1 in the common voltage generating circuit 51 is represented as follows.

V1=Vref×R11×RB1/(R11×RA1+R11×RB1+RA1×RB1)+V2×RA1×RB1/(R11×RA1+R11×RB1+RA1×RB1) EQUATION (1)

When the total resistance value (RA1+RB1) of the variable resistance VR1 is one third or less of the resistance R11, the second term on the right side of the formula (1) can almost be ignored compared to the first term, and the third term in the denominator of the first term on the right side of the formula (1) can be ignored compared to the first and second terms, it is represented as follows.

V1≈Vref×RB1(RA1+RB1) EQUATION (2)

On the other hand, if the resistance from the variable portion of the variable resistance VR2 to the constant voltage Vref is RA2, and the resistance from the variable portion to the GND is RB2, the variable resistance VR2 is represented as follows

V2=Vref×RB2/(RA1+RB2) EQUATION (3)

The common voltages VCOMH and VCOML are represented as follows.

VCOMH=V2×(R11+R12)/R11−V1×R12/R11 EQUATION (4)

VCOML=V2×(R21+R22)/R21−Vref×R22/R21 EQUATION (5)

Here, when the resistance values of the resistances R11 and R21 are equal and the resistance values of the resistances R12 and R22 are equal, the common voltage difference Vsw (=VCOMH−VCOML) is represented as follows.

Vsw=(Vref−V1)×R12/R11 EQUATION (6)

Therefore, the common voltage generating circuit 51 according to this embodiment can adjust the common voltage difference Vsw only by the voltage V1, that is, the variable resistance VR1, and can adjust the common voltage VCOML only by the variable resistance VR2. Accordingly the common voltage generating circuit 51 can adjust the common voltage amplitude and common voltage L level independently with the variable resistance so that adjustment of the common voltage level is easy.

The common voltage generating circuit 51 according to this embodiment has the output equipped with the capacitances C1 and C2. If the capacitance values thereof are sufficiently larger than all the common electrodes of the liquid crystal display, the common voltage generating circuit 51 has almost no output resistance so that the driving time of the common drive circuit 4 will not be thereby influenced.

If the resistance from the variable portion to the constant voltage Vref is RA2 and the resistance from the variable portion to the GND is RB2 as to the variable resistance VR2, a voltage V2 does not depend on the resistances R21 and R22 and can be determined according to the values of the resistances RA2 and RB2. Here, as the common voltage VCOMH depends on the voltages V1 and V2 and the common voltage VCOML only depends on the voltages V2, it is possible, in the common voltage generating circuit according to the present invention, to have a common voltage difference Vsw (=VCOMH−VCOML) adjusted only by the voltage V1, that is, the variable resistance VR1 and have the common voltage VCOML adjusted only by the variable resistance VR2. In general, considering operating time and power consumption, the resistances R11, R12, R21 and R22 are several megaohms or so whereas the resistance (RA2+RB2) is designed to be the same value or larger such as several megaohms to several tens of megaohms. Therefore, the resistance (RA1+RB1) is one third or less of at least one of the other resistances (for example resistance (RA2+RB2) and resistances R11, R12, R21 and R22), and in many cases, one third or less of all the other resistances.

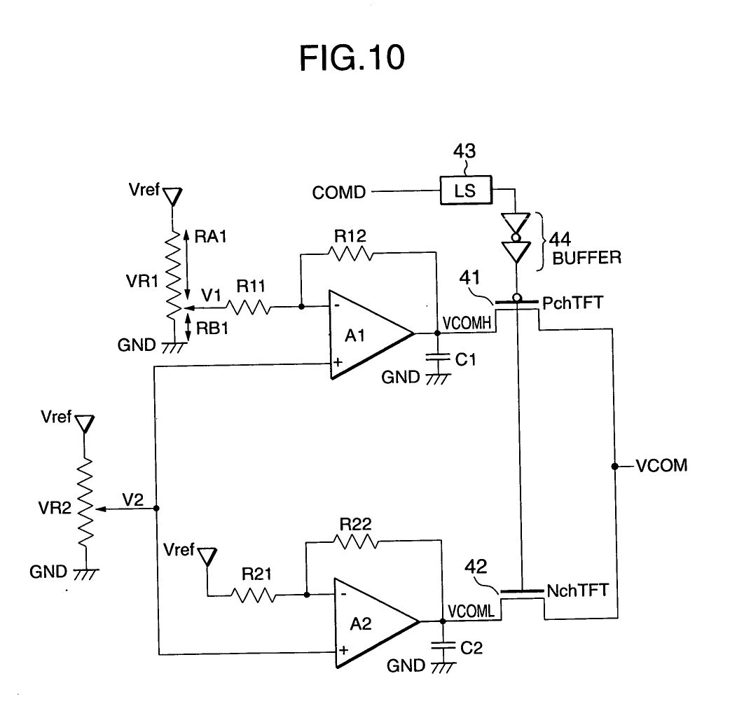

FIG. 10 is a diagram showing an illustrative embodiment of combining the common voltage generating circuit 51 in FIG. 9 with the common drive circuit 4 in FIG. 6. It is also possible to combine it with the common drive circuit of another method. While in this embodiment the voltages applied to both terminals of the variable resistances VR1 and VR2 are the constant voltages Vref and GND, adequate constant voltages may be used for these voltages.

Thus, according to this embodiment, it is possible to make the circuit area small and make the frame narrower by adopting as the common drive circuit 4 each of the configuration examples of the first embodiment of the present invention shown in FIGS. 4, 6 and 7 respectively.

According to this embodiment, by adopting the configuration example shown in FIG. 9 as the common voltage generating circuit 51 and connecting the resistances and capacitances to the outside of the liquid crystal display substrate through an input pad, it is possible to make the liquid crystal display wherein the gate driver circuit 3, common drive circuit 4, and common voltage generating circuit 51 are integrated, with no wasteful area but having the symmetric frame and capable of easily adjusting the common voltage level. Furthermore, this embodiment is also applicable to the liquid crystal display where the data driver circuit 2 is not integrated on the liquid crystal display substrate 10 and where the other circuits are integrated thereon.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. Therefore, the present invention is not intended to be limited to the embodiments described herein but is to be accorded the widest scope as defined by the limitations of the claims and equivalents.

What is claimed is:

1. A drive circuit comprising:
a first voltage supply;
a second voltage supply for providing a voltage that is lower than a voltage of said first voltage supply;
at least one first transistor including either a drain or a source terminal connected to said first voltage supply;
at least one second transistor including either a drain or source terminal connected to said second voltage supply;
at least one signal line connected to each gate terminal of said first and second transistor; and
at least one capacitance load connected to respective terminals of said first and said second transistors not connected to said first and second voltage supplies,
wherein said signal line conveys signals having a high level that is substantially the same or higher than the voltage of said first voltage supply and having a low level that is substantially the same or lower than the voltage of said second voltage supply.

2. The drive circuit according to claim 1,
wherein at least said drive circuit, a display portion and a gate driver circuit for controlling switching of pixels of each line in said display portion are mounted on a substrate, and
wherein said driving circuit is disposed on a position opposite to said gate driver circuit and said display portion therebetween.

3. The drive circuit according to claim 1,
wherein said at least one first transistor comprises P-type transistor and said at least one second transistors comprises N-type transistor, and
wherein said gate terminals of said first and second transistors are connected to common signal lines.

4. The drive circuit according to claim 2,
wherein P-type transistors and N-type transistors are connected in parallel to be said first transistor, and N-type transistors and P-type transistors are connected in parallel to be said second transistor,
wherein respective gates of said P-type transistors of said first transistor and said N-type transistor of said second transistors are connected to one said signal line, and respective gates of the N-type transistors of said first transistor and the P-type transistors of said second transistor are connected to an inversion signal line of one said signal line.

5. The drive circuit according to claim 4,
wherein a high-level voltage of each signal of said signal line and said inversion signal line is a high-level line voltage of said gate driver and
wherein a low-level voltage of each signal of said signal line and said inversion signal line is a low-level line voltage of said gate driver.

6. The drive circuit according to claim 2,
wherein said first and second transistors are comprised of thin-film transistors.

7. The drive circuit according to claim 2,
wherein said display portion comprises a liquid crystal display.

8. A voltage generating circuit for generating a providing voltage to a drive circuit comprising:
a first and a second variable resistances for adjusting said providing voltage;
a first operational amplifier outputting a high level of said providing voltage, and a non-inversion input thereof connected to a variable portion of said second variable resistance;
a second operational amplifier outputting a low level of said providing voltage, and a non-inversion input thereof connected to a variable portion of said second variable resistance;
a first resistance connecting a variable portion of said first variable resistances to an inversion input of said first operational amplifier;
a second resistance wherein one terminal of said second resistance connected to said inversion input of said first operational amplifier, and the other terminal of said second resistance connected to output of said first operational amplifier;
a third resistance connecting a constant voltage supply to an inversion input of said second operational amplifier;
a fourth resistance wherein one terminal of said fourth resistance connects to a inversion input of said second operational amplifier, and the other terminal of said fourth resistance connects to an output of said second operational amplifier;
wherein total resistance of said first variable resistance is a resistance value of one third or less of at least one of the total resistance of said second variable resistance and resistance of said first operational amplifier, said second operational amplifier, said first resistance, said second resistance, said third resistance, and said fourth resistance; and
wherein said first and second variable resistances adjust a low level of said providing voltage and a voltage difference between a high level and the low level of said providing voltage.

9. The voltage generating circuit according to claim 8,
wherein said voltage generating circuit, a display portion, a drive circuit, a gate driver circuit for controlling switching of pixels of each line in said display portion are mounted on a substrate and
wherein said voltage generating circuit and said driving circuit are disposed opposite to said gate driver circuit and said display portion therebetween.

10. A voltage generating circuit for generating a providing voltage to a drive circuit comprising:
a first and a second variable resistances for adjusting said providing voltage;
a first operational amplifier outputting a high level of said providing voltage, and a non-inversion input thereof connected to a variable portion of said second variable resistance;
a second operational amplifier outputting a low level of said providing voltage, and a non-inversion input thereof connected to a variable portion of said second variable resistance;
a first resistance connecting a variable portion of said first variable resistances to an inversion input of said first operational amplifier;
a second resistance wherein one terminal of said second resistance connected to said inversion input of said first operational amplifier, and the other terminal of said second resistance connected to output of said first operational amplifier;
a first capacitance, wherein one terminal of said first capacitance is connected to said output of said first operational amplifier, and the other terminal of said first capacitance connected to a constant voltage;
a third resistance connecting a constant voltage supply to an inversion input of said second operational amplifier;
a fourth resistance wherein one terminal of said fourth resistance connects to a inversion input of said second operational amplifier, and the other terminal of said fourth resistance connects to an output of said second operational amplifier;
a second capacitance, wherein one terminal of said second capacitance is connected to said output of said second operational amplifier, and the other terminal of said second capacitance connected to the constant voltage,
wherein total resistance of said first variable resistance is one third or less of at least one of the total resistance values of said second variable resistance and resistance of said first operational amplifier, said second operational amplifier, said first resistance, said second resistance, said third resistance, and said fourth resistance.

11. The voltage generating circuit according to claim 10,
wherein said voltage generating circuit, a display portion, said drive circuit, and a gate driver circuit for controlling switching of pixels of each line in a display portion are mounted on a substrate, and
wherein said voltage generating circuit and said driving circuit are disposed on a position opposite to said gate driver circuit and said display portion therebetween.

12. The voltage generating circuit according to claim 9,
wherein at least one of said resistances and said capacitances are disposed outside said substrate and are connected through an input pad of said display portion.

13. The voltage generating circuit according to claim 11,
wherein at least one of said resistances and said capacitances are disposed outside said substrate, and are connected through an input pad of said display portion.

14. The voltage generating circuit according to claim 9,
wherein said drive circuit comprises a drive circuit comprising; a first voltage supply, a second voltage supply for providing a voltage that is lower than a voltage of said first voltage supply, at least one first transistor including either a drain or a source terminal connected to said first voltage supply, at least one second transistor including either a drain or source terminal connected to said second voltage supply, at least one signal line connected to each gate terminal of said first and second transistor, and at least one capacitance load connected to respective terminals of said first and said second transistors not connected to said first and second voltage supplies, wherein said signal line conveys signals having a high level that is substantially the same or higher than the voltage of said first voltage supply and having a low level that is substantially same or lower than the voltage of said second voltage supply.

15. The voltage generating circuit according to claim 11,
wherein said drive circuit comprises a drive circuit comprising; a first voltage supply, a second voltage supply for providing a voltage that is lower than a voltage of said first voltage supply, at least one first transistor including either a drain or a source terminal connected to said first voltage supply, at least one second transistor including either a drain or source terminal connected to said second voltage supply, at least one signal line connected to each gate terminal of said first and second transistor, and at least one capacitance load connected to respective terminals of said first and said second transistors not connected to said first and second voltage supplies, wherein said signal line conveys signals having a high level that is substantially the same or higher than the voltage of said first voltage supply and having a low level that is substantially the same or lower than the voltage of said second voltage supply.

16. A display comprising:
a substrate;
a display portion integrated on said substrate;
a gate driver circuit for controlling switching of pixels of each line in a display portion;
a drive circuit for said display portion for simultaneously driving capacitance loads in said display portion,
wherein said drive circuit is disposed on a position opposite to said gate driver circuit and said display portion therebetween.

17. The display according to claim 16,
wherein said drive circuit comprises:
a first voltage supply;
a second voltage supply that provides a voltage that is lower than a voltage of said first voltage supply;
at least one first transistor including either a drain or a source terminal connected to said first voltage supply;
at least one second transistor including either a drain or source terminal connected to said second voltage supply;
at least one signal line connected to each gate terminal of said first and second transistor; and
at least one capacitance load connected to respective terminals of said first and said second transistors that are not connected to said first and second voltage supplies,
wherein said signal line conveys signals having a high level that is substantially the same or higher than the voltage of said first voltage supply and having a low level that is substantially the same or lower than the voltage of said second voltage supply.

18. The display unit according to claim 17,
wherein said at least first transistor comprises P-type transistors and said at least second transistor comprises N-type transistors, and
wherein said gate terminals of said first and second transistors are connected to common signal lines.

19. The display unit according to claim 17,
wherein P-type transistors and N-type transistors are connected in parallel to be said first transistor, and N-type transistors and P-type transistors are connected in parallel to be said second transistor,
wherein respective gates of said P-type transistors of said first transistor and said N-type transistors of said second transistor are connected to one said signal line, and respective gates of the N-type transistors of said first transistor and the P-type transistors of said second transistor are connected to an inversion signal line of one said signal line.

20. The display unit according to claim 19,
wherein a high-level voltage of each signal of said signal line and said inversion signal line is a high-level line voltage of said gate driver and
wherein a low-level voltage of each signal of said signal line and said inversion signal line is a low-level line voltage of said gate driver.

21. The display unit according to claim 17,
wherein all of said transistors are comprised of thin-film transistors.

22. A display comprising:
a substrate;
a display portion integrated on said substrate;
a gate driver circuit for controlling switching of pixels of each line in said display portion;
a drive circuit for said display portion for simultaneously driving capacitive loads in said display portion; and
a voltage generating circuit for generating a providing voltage to said drive circuit,
wherein said voltage generating circuit disposed at a position opposite to said gate driver circuit and said display portion therebetween.

23. The display unit according to claim 22,
wherein said voltage generating circuit comprises first and second variable resistances for adjusting said providing voltage, a first and a second variable resistances for adjusting said providing voltage, a first operational amplifier outputting a high level of said providing voltage, and a non-inversion input thereof connected to a variable portion of said second variable resistance, a second operational amplifier outputting a low level of said providing voltage, and a non-inversion input thereof connected to a variable portion of said second variable resistance, a first resistance connecting a variable portion of said first variable resistances to an inversion input of said first operational amplifier, a second resistance wherein one terminal of said second resistance connected to said inversion input of said first operational amplifier, and the other terminal of said second resistance connected to output of said first operational amplifier, a third resistance connecting a constant voltage supply to an inversion input of said second operational amplifier, and a fourth resistance wherein one terminal of said fourth resistance connects to a inversion input of said second operational amplifier, and the other terminal of said fourth resistance connects to an output of said second operational amplifier,
wherein total resistance of said first variable resistance is a resistance value of one third or less of at least one of the total resistance of said second variable resistance and resistance of said first operational amplifier, said second operational amplifier, said first resistance, said second resistance, said third resistance, and said fourth resistance; and
wherein said first and second variable resistances adjust a low level of said providing voltage and a voltage difference between a high level and the low level of said providing voltage.

24. The display unit according to claim 22,
wherein said voltage generating circuit comprises a first and a second variable resistances for adjusting said providing voltage;
a first operational amplifier outputting a high level of said providing voltage, and a non-inversion input thereof connected to a variable portion of said second variable resistance;
a second operational amplifier outputting a low level of said providing voltage, and a non-inversion input thereof connected to a variable portion of said second variable resistance;
a first resistance connecting a variable portion of said first variable resistances to an inversion input of said first operational amplifier;
a second resistance wherein one terminal of said second resistance connected to said inversion input of said first operational amplifier, and the other terminal thereof connected to output of said first operational amplifier;
a first capacitance connected to said output of said first operational amplifier, and the other terminal thereof connected to a constant voltage;
a third resistance connecting a constant voltage supply to an inversion input of said second operational amplifier;
a fourth resistance wherein one terminal thereof connects to a inversion input of said second operational amplifier, and the other terminal thereof connects to an output of said second operational amplifier;
a second capacitance wherein one terminal thereof connected to said output of said second operational amplifier, and the other terminal thereof connected to the constant voltage,
wherein total resistance of said first variable resistance is one third or less of other resistance values.

25. The display unit according to claim 23,
wherein said drive circuit comprises a drive circuit comprising a first voltage supply, a second voltage supply for providing a voltage that is lower than a voltage of said first voltage supply, at least one first transistor including either a drain or a source terminal connected to said first voltage supply, at least one second transistor including either a drain or source terminal connected to said second voltage supply, at least one signal line connected to each gate terminal of said first and second transistor, and at least one capacitance load connected to respective terminals of said first and said second transistors not connected to said first and second voltage supplies, wherein said signal line conveys signals having a high level that is substantially the same or higher than the voltage of said first voltage supply and having a low level that is substantially the same or lower than the voltage of said second voltage supply.

26. The display unit according to claim 24,
wherein said drive circuit comprises a drive circuit comprising a first voltage supply, a second voltage supply for providing a voltage that is lower than a voltage of said first voltage supply, at least one first transistor including either a drain or a source terminal connected to said first voltage supply, at least one second transistor including either a drain or source terminal connected to said second voltage supply, at least one signal line connected to each gate terminal of said first and second transistor, and at least one capacitance load connected to respective terminals of said first and said second transistors not connected to said first and second voltage supplies, wherein said signal line conveys signals having a high level that is substantially the same or higher than the voltage of said first voltage supply and having a low level that is substantially the same or lower than the voltage of said second voltage supply.
